(19) United States
(12) Patent Application Publication
(10) Pub. No.: US 2013/0153689 A1
(43) Pub. Date: Jun. 20, 2013

(54) ELECTROSTATIC ATOMIZING APPARATUS

(71) Applicants: Hidesato Uegaki, Shiga (JP); Yutaka Uratani, Shiga (JP)

(72) Inventors: Hidesato Uegaki, Shiga (JP); Yutaka Uratani, Shiga (JP)

(73) Assignee: PANASONIC CORPORATION, Osaka (JP)

(21) Appl. No.: 13/819,185

(22) PCT Filed: Sep. 14, 2011
(86) PCT No.: PCT/JP2011/070956

§ 371 Date: Feb. 26, 2013

(30) Foreign Application Priority Data
Sep. 30, 2010 (JP) 2010-221173

(51) Int. Cl. B05B 5/053

(52) U.S. Cl. CPC B05B 5/053
USPC 239/690

(57) ABSTRACT

An electrostatic atomizing apparatus includes a discharge electrode, a discharged electrode, a liquid supplying unit, a high voltage generating unit, and a controller. The discharged electrode is used to cause discharge between the discharged electrode and the discharge electrode. The liquid supplying unit supplies a liquid for atomization to the discharge electrode. The high voltage generating unit applies a high voltage to the discharged electrode. The discharge current detecting unit is arranged between the high voltage generating unit and the discharged electrode and detects a discharge current flowing through the discharged electrode. The controller controls, based on the discharge current detected by the discharge current detecting unit, the high voltage generated by the high voltage generating unit so as to achieve a predetermined discharge current.

### TECHNICAL FIELD

The present invention relates to an electrostatic atomizing apparatus.

### BACKGROUND ART

There is conventionally known an electrostatic atomizing apparatus. The electrostatic atomizing apparatus applies a high voltage between a discharge electrode and an opposing electrode (discharged electrode) and supplies water to the discharge electrode to form charged micro-particle water and negative ions. In the electrostatic atomizing apparatus, although generally the opposing electrode is grounded and a negative high voltage is applied to the discharge electrode, there is also an arrangement in which the discharge electrode is grounded and a positive high voltage is applied to the opposing electrode (see, for example, Patent Document 1). With such an arrangement, the negative ions of low mass that are generated from the discharge electrode (atomizing electrode) become attracted to the opposing electrode. This prevents a target object from being charged and effectively supplies charged micro-particle water of high mass to the target object.

### PRIOR ART DOCUMENTS

Patent Document 1: Japanese Laid-Open Patent Publication No. 2008-149243

### SUMMARY OF THE INVENTION

### Problems to be Solved by the Invention

In the electrostatic atomizing apparatus, discharging is destabilized when an amount of liquid attached to the discharge electrode changes. There is a need to control discharging based on detection of a discharge current.

Accordingly, it is an object of the present invention to provide an electrostatic atomizing apparatus with which discharging may be stabilized even when an amount of liquid attached to the discharge electrode changes.

### Means for Solving the Problems

One aspect of the present invention is an electrostatic atomizing apparatus. The apparatus includes a discharge electrode, a discharged electrode used to perform discharging between the discharged electrode and the discharge electrode, a liquid supplying unit that supplies a liquid for atomization to the discharge electrode, a high voltage generating unit that applies a high voltage to the discharged electrode, a discharge current detecting unit arranged between the high voltage generating unit and the discharged electrode, wherein the discharge current detecting unit detects a discharge current flowing through the discharged electrode, and a controller that controls the high voltage generated by the high voltage generating unit based on the discharge current detected by the discharge current detecting unit so as to achieve a predetermined discharge current. With this structure, the controller controls the high voltage applied to the discharged electrode based on the detection result of the discharge current. Thus, even when an amount of the liquid attached to the discharge electrode changes, an appropriate discharge current may be generated to cause discharging with stability.

### BRIEF DESCRIPTION OF THE DRAWINGS

FIG. 1 is a block circuit diagram of an electrostatic atomizing apparatus according to a first embodiment.

FIG. 2 is a block circuit diagram of an electrostatic atomizing apparatus according to a second embodiment.

FIG. 3 is a block circuit diagram illustrating another example of an electrostatic atomizing apparatus.

### EMBODIMENTS OF THE INVENTION

### First Embodiment

An electrostatic atomizing apparatus 1 according to a first embodiment will now be described with reference to the drawings.

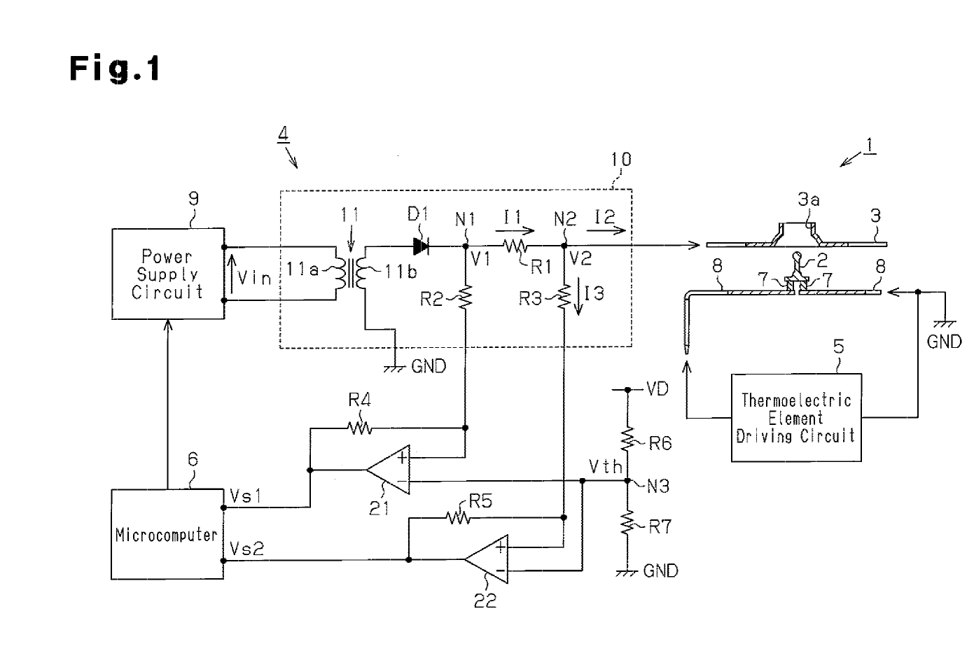

As illustrated in FIG. 1, the electrostatic atomizing apparatus 1 includes a discharge electrode 2, an opposing electrode 3 that serves as a discharged electrode, a high voltage generating circuit 4, a thermoelectric element driving circuit 5, and a control circuit (microcomputer) 6 that serves as a controller. The discharge electrode 2 is made of a metal member with electrical conductivity and has a substantially circular cylindrical shape projecting toward the opposing electrode 3 that is disposed in opposition. In the present example, the opposing electrode 3 includes a central portion that is formed in a dome shape covering an upper surface of the discharge electrode 2. The central portion has an opening that serves as a mist emission port 3a. Further, the opposing electrode 3 includes a peripheral portion around the dome-shaped central portion that is formed in a planar shape with respect to the discharge electrode 2. The opposing electrode 3 is connected to the high voltage generating circuit 4. The discharge electrode 2 includes a tip portion, which is arranged so as to be directed toward the mist emission port 3a of the opposing electrode 3, and a basal portion, which is arranged in contact with a plurality of thermoelectric elements 7.

The thermoelectric elements 7 include N-type thermoelectric elements and P-type thermoelectric elements. The N-type and P-type thermoelectric elements are each formed, for example, of a BiTe-based thermoelectric material and connected electrically to a heat radiating electrode 8 arranged in opposition to the discharge electrode 2. The heat radiating electrode 8 has a flat plate-like shape so as to induce dissipation of heat generated by a cooling action of the thermoelectric elements 7. Further, the heat radiating electrode 8 is connected to the thermoelectric element driving circuit 5 that generates a voltage for driving the thermoelectric elements 7. The discharge electrode 2 serves as a portion of an electrical circuit that includes the thermoelectric elements 7. The thermoelectric element driving circuit 5 supplies a power supply voltage (of a few volts) to the thermoelectric elements 7 via the heat radiating electrode 8 to cause a cooling action. The thermoelectric elements 7 cool the discharge electrode 2 while performing a heat radiating operation via the heat radiating electrode 8 to thereby form condensed water on the discharge electrode 2 from the moisture in air.

The high voltage generating circuit 4 includes a power supply circuit 9 and a high voltage transformer unit 10. The high voltage transformer unit 10 includes a transformer 11 serving as a high voltage generating unit that boosts a voltage supplied from the power supply circuit 9. The power supply circuit 9 includes a DC power supply circuit and a switching circuit, and is connected to a primary winding 11a of the transformer 11. The power supply circuit 9 applies a pulse-shaped power supply voltage Vin or a sinusoidal power supply voltage Vin to the primary winding 11a of the transformer 11. The transformer 11 boosts the pulse-shaped power supply voltage Vin or the sinusoidal power supply voltage Vin, which is applied to the primary winding 11a, to a high-voltage secondary voltage and outputs the secondary voltage to a secondary winding 11b. An anode of a diode D1 is connected to a positive terminal of the secondary winding 11b. A cathode of the diode D1 is connected to the opposing electrode 3 via a resistor R1. Thus, the secondary voltage output from the secondary winding 11b is applied as a positive high voltage (of several kilovolts) to the opposing electrode 3 via the diode D1 and the resistor R1.

Here, in the electrostatic atomizing apparatus 1, although a potential of several volts is applied to the discharge electrode 2 by the thermoelectric element driving circuit 5, the potential is close to a ground potential (zero volts) relative to the opposing electrode 3 to which the high voltage of several kilovolts is applied. Thus, when the high voltage is applied to the opposing electrode 3 in a state in which condensed water is held on the tip portion of the discharge electrode 2, discharging occurs across the discharge electrode 2 and the opposing electrode 3.

In the discharging operation, the condensed water held on the tip portion of the discharge electrode 2 is charged, and a Coulomb force acts on the condensed water so as to locally raise a liquid surface of the condensed water and form a conical shape (Taylor cone). As a result, electric charge concentrates at a distal end of the Taylor cone, and electrostatic atomization is performed by the repetitive fission/scattering (Rayleigh fission) of the water subjected to a repulsive force of the highly densified electric charge. This generates a large amount of charged micro-particle water having a nanometer size and containing active species. The charged micro-particle water is emitted through the mist emission port 3a.

In the electrostatic atomizing apparatus 1, when the condensed water on the discharge electrode 2 decreases, the Taylor cone becomes small. This increases a distance from the distal end of the Taylor cone to the opposing electrode 3 and decreases a discharge current I2. When the amount of water on the discharge electrode 2 decreases further, the discharging no longer occurs across the condensed water on the discharge electrode 2 and the opposing electrode 3 but discharging (air discharging) occurs across the discharge electrode 2 and the opposing electrode 3. As a result, the electrostatic atomization stops.

Oppositely, when the amount of the condensed water on the discharge electrode 2 increases, the Taylor cone becomes large. This decreases the distance from the distal end of the Taylor cone to the opposing electrode 3 and increases the discharge current I2. When the amount of the condensed water on the discharge electrode 2 increases further, and the distance between the opposing electrode 3 and the condensed water becomes too short, a short-circuit current flows so that a mist having the intended particle diameter cannot be obtained and an ozone concentration increases due to generation of a large amount of ozone.

Accordingly, there is a need to prevent the air from discharging and also to prevent the generation of a large amount of ozone due to excessive flow of the discharge current I2 that is induced by an excessive attachment of the condensed water on the discharge electrode 2. The control circuit 6 controls the power supply circuit 9 to generate the secondary voltage at the transformer 11 in a manner such that the secondary voltage is no more than a voltage (air discharging voltage) at which air discharging occurs and the secondary voltage is decreased when the discharge current I2 flows excessively to prevent the ozone concentration from becoming high.

In performing such control, the control circuit 6 detects a voltage V1 at a node N1 between the diode D1 and the resistor R1, and a voltage V2 at a node N2 between the resistor R1 and the opposing electrode 3, and computes the discharge current I2.

In the present example, the voltage V1 at the node N1 is input into a non-inverting input terminal of an operational amplifier 21 via a resistor R2. The non-inverting input terminal of the operational amplifier 21 is connected to an output terminal of the operational amplifier itself via a resistor R4 so that an output signal of the operational amplifier 21 is fed back via the resistor R4. The output terminal of the operational amplifier 21 is connected to a first input terminal of the control circuit 6. An inverting input terminal of the operational amplifier 21 is connected to a node N3 between resistors R6 and R7 that divide a predetermined voltage VD. Thus, a reference voltage Vth obtained by dividing the predetermined voltage VD is input into the inverting input terminal of the operational amplifier 21. The operational amplifier 21 amplifies the voltage V1 at the node N1 to generate an output voltage Vs1 and supplies the output voltage Vs1 to the first input terminal of the control circuit 6.

Similarly, the voltage V2 at the node N2 is input into a non-inverting input terminal of an operational amplifier 22 via a resistor R3. The non-inverting input terminal of the operational amplifier 22 is connected to an output terminal of the operational amplifier itself via a resistor R5 so that an output signal of the operational amplifier 22 is fed back via the resistor R5. The output terminal of the operational amplifier 22 is connected to a second input terminal of the control circuit 6. An inverting input terminal of the operational amplifier 22 is connected to the node N3. Thus, the reference voltage Vth is also input into the inverting input terminal of the operational amplifier 22. The operational amplifier 22 amplifies the voltage V2 at the node N2 to generate an output voltage Vs2 and supplies the output voltage Vs2 to the second input terminal of the control circuit 6.

In the present example, a discharge current detecting unit includes the resistors R1 and R3 and the operational amplifiers 21 and 22. Here, a current I1 flowing through the resistor R1 may be calculated from a difference between the voltage V1 at the node N1 and the voltage V2 at the node N2 and a resistance value of the resistor R1. Further, a current I3 flowing through the resistor R3 may be calculated from the voltage V2 at the node N2 and a resistance value of the resistor R3. Thus, the discharge current I2 may be calculated from a difference (I1-I3) between the current I3 and the current I1. The control circuit 6 uses such a formula for calculating the discharge current I2 to calculate the value of the discharge current I2 from the output voltages Vs1 and Vs2 (voltages V1 and V2). The control circuit 6 adjusts a magnitude of the power supply voltage Vin based on the calculated discharge current I2 to control the secondary voltage output from the secondary winding 11b of the transformer 11 to be within a preferable range described above.

Accordingly, the discharge current I2 may be detected with high precision even in the electrostatic atomizing apparatus 1 that adopts the structure where a positive high voltage is applied to the opposing electrode 3. Thus, the discharging is stabilized even when the amount of condensed water attached to the discharge electrode 2 changes. This allows for preventing air discharging and generation of a large amount of ozone.

The first embodiment has the advantages described below.

(1) The high voltage generated at the secondary winding 11b of the transformer 11 is applied between the discharge electrode 2 and the opposing electrode 3 via the diode D1 and the resistor R1. The voltage V1 at the node N1 between the resistor R1 and the diode D1 is input into the operational amplifier 21 via the resistor R2. The voltage V2 at the node N2 between the resistor R1 and the opposing electrode 3 is input into the operational amplifier 22 via the resistor R3. The control circuit 6 recognizes the voltages V1 and V2 at the nodes N1 and N2 based on the output voltages Vs1 and Vs2 output from the operational amplifiers 21 and 22. The control circuit 6 determines the currents I1 and I3 flowing through the resistors R1 and R3 from the voltages V1 and V2 and the resistance values of the resistors R1 and R3 and calculates the discharge current I2. The control circuit 6 controls the power supply voltage Vin in accordance with the discharge current I2. Thus, the discharge current I2 may be detected with high precision even in the electrostatic atomizing apparatus 1 that adopts the structure where the positive high voltage is applied to the opposing electrode 3. This allows for appropriate control based on the detected discharge current I2. Accordingly, a preferable amount of charged micro-particle water may be generated while preventing air discharging and the generation of a large amount of ozone.

(2) The thermoelectric elements 7 are used as a liquid supplying unit that supplies a liquid to the discharge electrode 2. The thermoelectric elements 7 cool the discharge electrode 2 to form condensed water from the moisture in the air and thereby supplies water to the discharge electrode 2. Therefore, an apparatus for storing and supplying the liquid is unnecessary and there is also no need for supplying the liquid from an external apparatus.

Second Embodiment

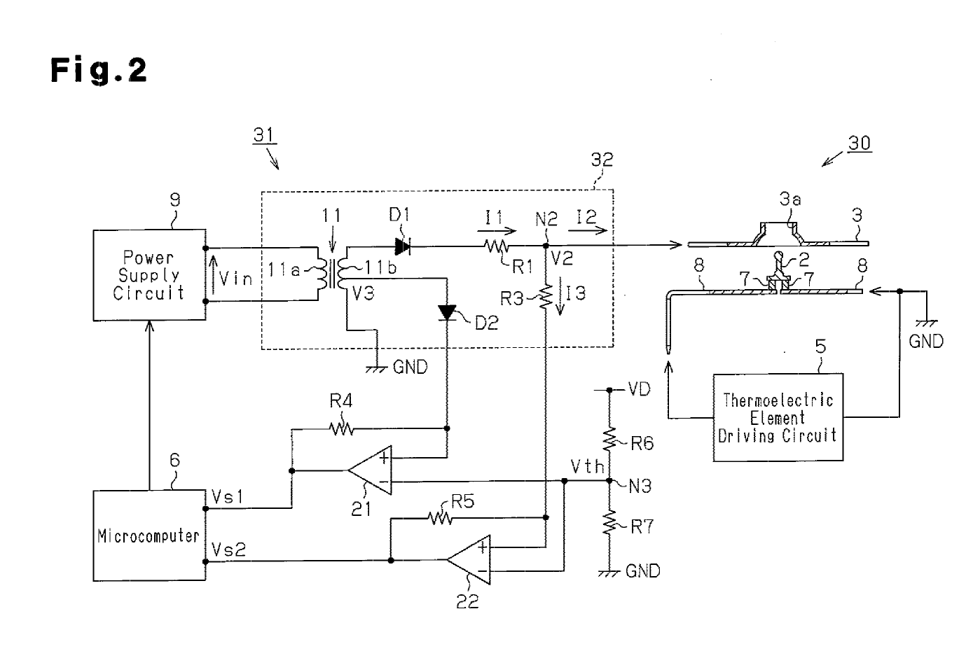

An electrostatic atomizing apparatus 30 according to a second embodiment will now be described with reference to FIG. 2. In the second embodiment, a high voltage generating circuit 31 is used in place of the high voltage generating circuit 4 of the first embodiment. Elements that are the same as those of the first embodiment are provided with the same symbols and description thereof will be omitted.

As illustrated in FIG. 2, in the electrostatic atomizing apparatus 30, a high voltage transformer unit 32 of the high voltage generating circuit 31 includes a diode D2 in place of the resistor R2 of the first embodiment. An anode of the diode D2 is connected to a position corresponding to a predetermined winding number in the middle of the secondary winding 11b of the transformer 11. A cathode of the diode D2 is connected to the non-inverting input terminal of the operational amplifier 21. In this case, a voltage V3 generated at the predetermined winding number position of the secondary winding 11b is input into the operational amplifier 21 via the diode D2. Here, the connection position (winding number position) of the secondary winding lib is set so that the voltage input into the operational amplifier 21 via the diode D2 is equal to the voltage input into the operational amplifier 21 via the resistor R2 based on the voltage V1 at the node N1 in the first embodiment. That is, the voltage V3 generated at the predetermined winding number position in the middle of the secondary winding 11b is a voltage that is sufficiently lower than the voltage generated by the whole secondary winding 11b. Thus, the resistor R2 for voltage dropping used in the first embodiment is unnecessary. Therefore, in the structure of the second embodiment, the discharge current detecting unit may be formed using the resistors R1 and R3 and the operational amplifiers 21 and 22 in the same manner as the first embodiment while eliminating the expensive resistor R2 for withstanding a high voltage.

In addition, even when the connection configuration to the non-inverting input terminal of the operational amplifier 21 is modified as described above, the output voltage Vs1 output from the operational amplifier 21 is equal to that of the first embodiment. Thus, the control circuit 6 may calculate the discharge current I2 in the same manner as the first embodiment.

The second embodiment has the advantages described below.

(1) As with the advantage (1) of the first embodiment, even when the structure where the positive high voltage is applied to the opposing electrode 3 is adopted, the discharge current I2 may be detected with high precision and thus appropriate control may be performed.

(2) The detection of the discharge current I2 is performed in the same manner as the first embodiment by supplying the low voltage V3 from the predetermined winding number position in the middle of the secondary winding 11b of the transformer 11 into the operational amplifier 21 via the diode D2. Thus, the resistor R2 used in the first embodiment for voltage dropping, that is, the expensive resistor R2 for withstanding a high voltage is unnecessary. This reduces the cost of the apparatus 30.

(3) The thermoelectric elements 7 are also used in the second embodiment as the liquid supplying unit for supplying the liquid to the discharge electrode 2. Thus, an apparatus for storing and supplying the liquid is unnecessary, and there is also no need for supplying the liquid from an external apparatus.

The above embodiment may be modified as described below.

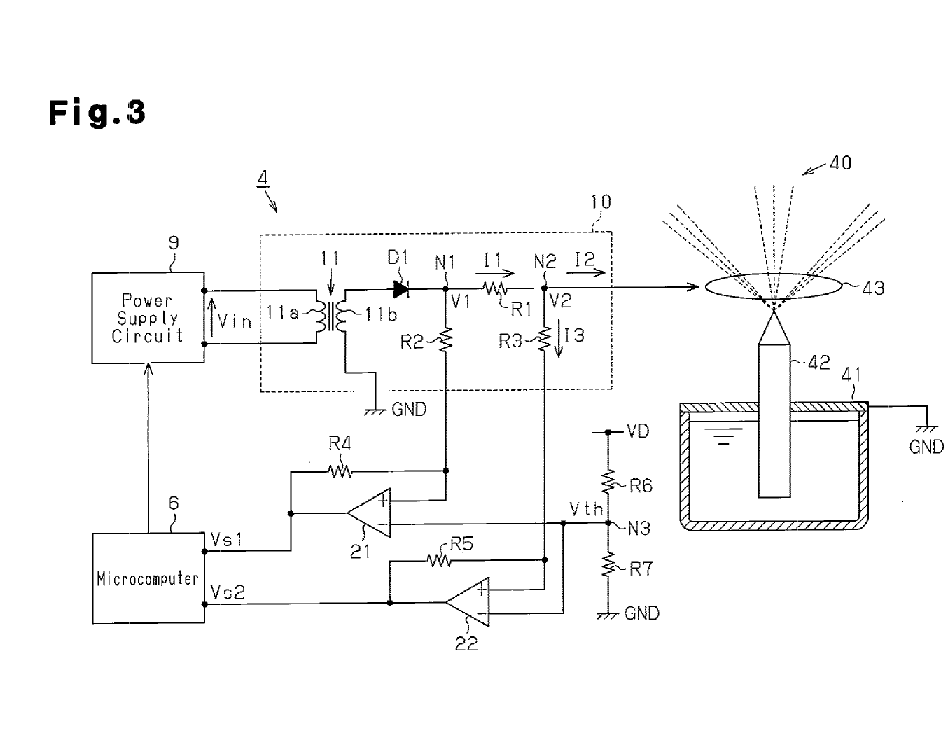

Although in the embodiments described above, the thermoelectric elements 7 are used as the liquid supplying unit that supplies the liquid to the discharge electrode 2, a water retaining unit 41 that serves as a liquid retaining unit may be arranged as the liquid supplying unit, for example, as in an electrostatic atomizing apparatus 40 illustrated in FIG. 3. With this structure, the liquid (that is, water) stored in the water retaining unit 41 is supplied to a discharge electrode 42 by use of a capillary phenomenon to perform discharging between the discharge electrode 42 and an opposing electrode 43 (discharged electrode). In this case, for example, a narrow pore extending from a base end portion to a distal portion of the discharge electrode 42 is formed in the discharge electrode 42. The base end portion of the discharge electrode 42 is disposed inside the water retaining unit 41 so that the capillary phenomenon occurs. In FIG. 3, although the high voltage generating circuit 4 of the first embodiment is arranged, this may be replaced by the high voltage generating circuit 31 of the second embodiment illustrated in FIG. 2.

The discharged electrode is not limited to the opposing electrode 3 arranged in opposition to the discharge electrode 2, such as in the embodiments described above, as long as discharging occurs with respect to the discharge electrode 2. For example, a discharged electrode may be arranged surrounding a periphery of the discharge electrode 2.

The structure of the circuit illustrated in each of the embodiments described above is merely an example. For example, the structure of the high voltage generating circuit 4 or 31 may be modified as suited.

In each of the embodiments described above, the discharge electrode 2 is formed as a portion of the electric circuit that includes the thermoelectric elements 7. However, an electric circuit connected to the discharge electrode 2 and an electric circuit connected to the thermoelectric elements 7 may be formed independently.

1. An electrostatic atomizing apparatus comprising:
a discharge electrode;
a discharged electrode used to perform discharging between the discharged electrode and the discharge electrode;
a liquid supplying unit that supplies a liquid for atomization to the discharge electrode;
a high voltage generating unit that applies a high voltage to the discharged electrode;
a discharge current detecting unit arranged between the high voltage generating unit and the discharged electrode, wherein the discharge current detecting unit detects a discharge current flowing through the discharged electrode; and
a controller that controls the high voltage generated by the high voltage generating unit based on the discharge current detected by the discharge current detecting unit so as to achieve a predetermined discharge current.

2. The electrostatic atomizing apparatus according to claim 1, wherein:
the discharge current detecting unit includes a first resistor arranged between the high voltage generating unit and the discharged electrode, and
a second resistor connected to a node between the first resistor and the discharged electrode and through which a portion of a current flowing through the first resistor flows; and
the controller determines the current flowing through the first resistor from a voltage applied to the first resistor and a resistance value of the first resistor, determines the current flowing through the second resistor from a voltage at the node connected to the second resistor and a resistance value of the second resistor, and determines the discharge current from the current flowing through the first resistor and the current flowing through the second resistor.

3. The electrostatic atomizing apparatus according to claim 2, wherein the discharge current detecting unit includes
a first operational amplifier connected via a third resistor to a node between the high voltage generating unit and the first resistor, wherein the first operational amplifier detects a voltage at the node between the high voltage generating unit and the first resistor, and
a second operational amplifier connected via the second resistor to the node between the first resistor and the discharged electrode, wherein the second operational amplifier detects a voltage at the node between the first resistor and the discharged electrode.

4. The electrostatic atomizing apparatus according to claim 2, wherein:
the first resistor includes one end that is electrically connected to a secondary winding of a transformer which serves as the high voltage generating unit; and
the discharge current detecting unit includes
a first operational amplifier electrically connected to a position corresponding to a predetermined winding number in a middle of the secondary winding, wherein the first operational amplifier detects a voltage at the position corresponding to the predetermined winding number as a voltage at the one end of the first resistor, and
a second operational amplifier connected via the second resistor to the node between the first resistor and the discharged electrode, wherein the second operational amplifier detects a voltage at the node between the first resistor and the discharged electrode.

5-6. (canceled)
